(19) United States
(12) Patent Application Publication
(10) Pub. No.: US 2007/0286443 A1
(43) Pub. Date: Dec. 13, 2007

(54) Cover for hearing device housing arrangement

(76) Inventors: Uli Gommel, Erlangen (DE); Joseph Sauer, Strullendorf (DE); Markus Trautner, Nuremberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/810,970

(22) Filed: Jun. 7, 2007

(30) Foreign Application Priority Data
Jun. 7, 2006 (DE) 10 2006 026 785.0

(51) Int. Cl. H04R 25/00

(52) U.S. Cl. 381/322; 381/324; 381/330

(57) ABSTRACT

The invention relates to a hearing device housing arrangement with the features of a hearing device housing and a cover which covers an area of the hearing device housing. The area is visible during normal wearing of the hearing device. The cover is able to be fastened to the surface of the hearing device housing in an essentially force-fit or form-fit manner.

### CROSS REFERENCE TO RELATED APPLICATIONS

This application claims priority of German application No. 10 2006 026 785.0 filed Jun. 07, 2006, which is incorporated by reference herein in its entirety.

### FIELD OF THE INVENTION

The invention relates to a hearing device having a hearing device housing and a cover, which covers an area of the hearing device housing.

### BACKGROUND OF THE INVENTION

Since hearing devices are worn constantly and can be partially visible during wear, they need to fulfill special cosmetic and/or optical specifications. Hearing device housings are thus preferably designed in a color tone which matches the skin.

Nevertheless, hearing device wearers have different skin and/or hair colors. It is thus advantageous if the color of the housing is able to be adjusted to the wearer. Until now, the whole housing had to be replaced for this purpose. This requires separating the device with the aid of an instrument and can only be carried out by specialized staff. When removing the housing, the sensitive electronics system of the hearing device is exposed and needs to be completely reassembled and recalibrated with new, colored housing shells. This is particularly complex in the case of sensitive hearing devices having directional microphones. Furthermore, the opened device is easily damaged.

### SUMMARY OF THE INVENTION

The object of the present invention thus consists in enabling a simple, optical adjustment of the housing, which can be carried out by the end customer himself without any great effort.

This object is achieved in accordance with the invention by a hearing device according to the claims.

The hearing device according to the invention has the following features:
a) a hearing device housing;
b) a cover, which covers an area of the hearing device housing;

with the cover essentially being fastened to the surface of the hearing device housing in a force-fit and/or form-fit manner, and with the cover covering the area of the hearing device housing, which is visible during normal wear of the hearing device.

The cover of the hearing device according to the invention is preferably designed in the manner of a clip, so that the area of the hearing device housing to be covered can be at least partially encompassed, so that the cover can be clamped to the hearing device without difficulties.

The cover is preferably designed as a cover shell.

According to a preferred embodiment of the invention, the area of the hearing device housing covered by the cover is recessed. Preferably, the attached cover is essentially flush with an area of the hearing device housing which is not covered.

The hearing device is preferably designed such that the cover can be fastened and/or removed without the aid of an additional instrument. In this way, the end customer is thus able to replace the cover him/herself.

The cover covers the whole area of the hearing device housing, which is visible during wear. In the context of the present invention, the term “wear of the hearing device” is understood to mean the wearing of the hearing device by a hearing device wearer, as is the case during normal use of the hearing device, i.e. on the ear. The term “area, which is visible during wear” is understood to mean the area of the hearing device housing, which can be seen by a third person during normal use of the hearing device, e.g. the upper area of the housing in the case of a behind-the-ear device.

The invention also relates to a cover, which can be used with the hearing device according to the invention.

### BRIEF DESCRIPTION OF THE DRAWINGS

The present invention is now described in more detail below, with reference to the appended drawings, in which;

FIG. 1 shows a perspective view of a hearing device housing arrangement for an inventive hearing device, with the cover being shown in a state fastened to the housing;

FIG. 2 shows a perspective view of the hearing device housing arrangement in FIG. 1, with the cover being shown in a state detached from the housing.

### DETAILED DESCRIPTION OF THE INVENTION

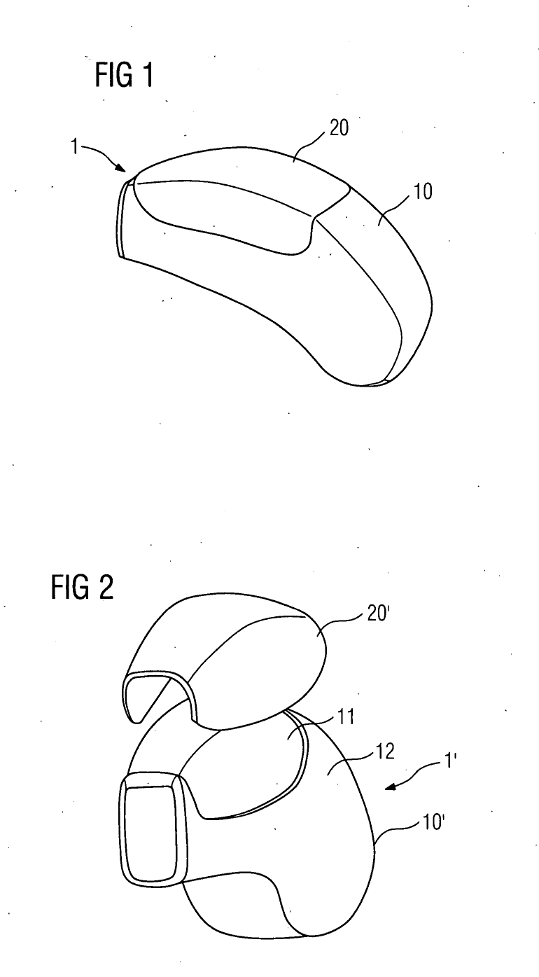

In FIG. 1, a hearing device housing arrangement 1 with a housing 10 and a cover 20 is shown. The illustrated hearing device housing arrangement 1 is for a behind-the-ear hearing device. It is designed such that the cover 20 covers the area of the hearing device housing which is visible during wear, said hearing device housing being visible above the pinna during wear.

FIG. 2 shows the hearing device housing arrangement 1′ having the cover 20′ in a status removed from the housing 10′. The cover 20′ is designed in the manner of a clip and can be clipped, snapped or clamped onto the housing 10′ without the use of further instruments.

The housing can consist of a number of shell parts, as is known to the person skilled in the art. The cover can be a plastic injection-molded part, a part deep-drawn from the plastic film, a punched and curved metal part or suchlike.

The cover can be designed in a plurality of colors, corresponding to the skin or hair color of the wearer. It is also possible to design the cover in fashionable colors.

In the exemplary embodiment shown, the housing 10′ has a more recessed area 11, which is covered by the cover 20, 20′. In the clipped-on state, the cover is flush with the area 12 of the housing 10, 10′ which is not covered.

The hearing device housing arrangement according to the invention enables a simple and uncomplicated adjustment of the housing, which can also be carried out by the end user him/herself.

The illustrated exemplary embodiment shows a behind-the-ear hearing device. It is likewise conceivable to design the hearing device housing arrangement according to the invention having a housing and a cover for an in-the-ear hearing device, so that the cover covers at least a part of the area of the in-the-ear hearing device which is visible from the outside.

1-6. (canceled)

7. A hearing device, comprising:
a hearing device housing; and
a cover that covers an area of the hearing device housing being visible during normal wearing of the hearing device, wherein the cover is configured to be force-fitly or form-fitly fastened to the hearing device housing.

8. The hearing device as claimed in claim 7, wherein the cover is a clip and clamped to the hearing device housing.

9. The hearing device as claimed in claim 8, wherein the clip at least partially encompasses the area of the hearing device housing to be covered.

10. The hearing device as claimed in claim 7, wherein the area of the hearing device housing covered by the cover is recessed.

11. The hearing device as claimed in claim 10, wherein the cover when is fastened to the hearing device housing is essentially flush with a remaining area of the hearing device housing that is not covered by the cover.

12. The hearing device as claimed in claim 7, wherein the cover is fastened to or removed from the hearing device housing by a method selected from the group consisting of: a push-fit fitting, a snap-on connection, and a clamp-connection.

13. The hearing device as claimed in claim 7, wherein the cover is selected from the group consisting of: a plastic injection-molded part, a part deep-drawn from a plastic film, and a punched and curved metal part.

14. The hearing device as claimed in claim 7, wherein a color of the cover corresponds to a skin or hair color of a wearer of the hearing device.

15. The hearing device as claimed in claim 7, wherein the cover is fastened to the hearing device housing without using an instrument.

16. A cover for covering an area of a hearing device housing being visible during normal wearing of a hearing device, wherein the cover is configured to be force-fitly or form-fitly fastened to the hearing device housing.

17. The cover as claimed in claim 16, wherein the cover is a clip and clamped to the hearing device housing.

18. The cover as claimed in claim 17, wherein the clip at least partially encompasses the area of the hearing device housing to be covered.

19. The cover as claimed in claim 16, wherein the area of the hearing device housing covered by the cover is recessed.

20. The cover as claimed in claim 19, wherein the cover when is fastened to the hearing device housing is essentially flush with a remaining area of the hearing device housing that is not covered by the cover.

21. The cover as claimed in claim 16, wherein the cover is fastened to or removed from the hearing device housing by a method selected from the group consisting of: a push-fit fitting, a snap-on connection, and a clamp-connection.

22. The cover as claimed in claim 16, wherein the cover is selected from the group consisting of: a plastic injection-molded part, a part deep-drawn from a plastic film, and a punched and curved metal part.

23. The cover as claimed in claim 16, wherein a color of the cover corresponds to a skin or hair color of a wearer of the hearing device.

24. The cover as claimed in claim 16, wherein the cover is fastened to the hearing device housing without using an instrument.

25. A method for adjusting a hearing device housing, comprising:
providing a cover; and
fastening the cover force-fitly or form-fitly to the hearing device housing for covering an area of the hearing device housing being visible during normal wearing of a hearing device.

26. The method as claimed in claim 25, wherein a color of the cover corresponds to a skin or hair color of a wearer of the hearing device.
